(19) United States
(12) Patent Application Publication
(10) Pub. No.: US 2025/0281980 A1
(43) Pub. Date: Sep. 11, 2025

(54) DEVICE, SYSTEM AND METHOD FOR GENERATING A 3D STRUCTURE

(71) Applicant: uppolluX GmbH & Co. KG, Tuttlingen (DE)

(72) Inventor: Daniel Baumann, Tuttlingen (DE)

(73) Assignee: uppolluX GmbH & Co. KG, Tuttlingen (DE)

(21) Appl. No.: 19/219,037

(22) Filed: May 27, 2025

Related U.S. Application Data
(63) Continuation of application No. PCT/EP2023/082826, filed on Nov. 23, 2023.

(30) Foreign Application Priority Data
Nov. 28, 2022 (DE) 10 2022 131 431.6

(51) Int. Cl. B22F 12/43; B22F 10/28; B22F 10/85; B28B 1/00; B28B 17/00; B29C 64/124; B29C 64/273; B29C 64/393; B33Y 10/00; B33Y 30/00; B33Y 50/02

(52) U.S. Cl. CPC B22F 12/43; B22F 10/28; B22F 10/85; B28B 1/001; B28B 17/0081; B29C 64/124; B29C 64/273; B29C 64/393; B33Y 10/00; B33Y 30/00; B33Y 50/02

(57) ABSTRACT

An apparatus for manufacturing a 3D structure from a starting material with a magnetocalorically excitable substance, on the basis of CAD/CAM data for the 3D structure includes: a control unit; a gradient field generator for generating a gradient field by means of which a defined field-free space in the starting material arranged in the working zone can be spatially encoded; and an alternating field generator for irradiating an alternating field into the working zone. The control unit is arranged to control the alternating field generator in such a way that the magnetocalorically excitable substance of the starting material in the spatially encoded field-free space can be excited by means of the alternating field in order to thermally induce polymerization, sintering or thermal structural decomposition of the starting material, preferably solely, in the defined field-free space.

### CROSS-REFERENCE TO RELATED APPLICATIONS

This continuation application claims priority to PCT/EP2023/082826 filed on Nov. 23, 2023, which has published as WO 2024/115268 A1 and also the German application number DE 10 2022 131 431.6 dated Nov. 28, 2022, the entire contents of which are fully incorporated herein with these references.

### FIELD OF THE INVENTION

The present invention relates to an apparatus, to a system and to a method for producing a three-dimensional (=3D) structure. Furthermore, the invention relates to a use of the apparatus and the system.

### BACKGROUND OF THE INVENTION

In 3D printing (=additive manufacturing), the fabrication of a three-dimensional structure takes place by a computer-controlled layer-by-layer buildup of one or more liquid or solid materials according to prespecified dimensions and shapes. Physical or chemical curing and/or melting processes take place during the buildup. Typical materials for 3D printing are plastics, synthetic resins, ceramics and metals. 3D printing is characterized by a cost-effective customizability of the 3D structure in terms of geometry, materiality and functionality, simultaneously with a high capacity for automation and decentralization. On the basis of CAD-optimized image files, a controlled, reproducible, and real-time-modulatable production of three-dimensional structures by an increasingly precise material deposition in a construction plan-adapted coordinate system is thus nowadays achieved by means of a wide variety of additive method technologies.

The dimensional accuracy of 3D structures produced using conventional 3D printing processes is not yet sufficient for many applications. Furthermore, the 3D printed structures can often only be subsequently postprocessed with great effort using other conventional machining or manufacturing processes and only to a limited extent or not at all inside the 3D structure.

### SUMMARY OF THE INVENTION

### Object of the Invention

It is the object of the invention to specify an apparatus and a system by means of which a predetermined 3D structure can be produced (generated) contactlessly without interrupting the manufacturing process and with a high resolution by machining a starting material. Furthermore, it is the object of the invention to provide a method for manufacturing a 3D structure.

### Solution of the Object According to the Invention

The object relating to the apparatus is achieved by an apparatus having the features specified in claim 1, and the object relating to the system is achieved by a system having the features specified in claim 6. The method according to the invention is specified in claim 7.

Advantageous further embodiments of the invention are the subject of the subclaims and the description.

### Apparatus According to the Invention

Detached from the technical process principles of the 3D printing systems and methods described above, an apparatus according to the invention is proposed by means of which a 3D structure based on CAD/CAM data of the 3D structure is made possible by processing a starting material comprising a magnetocalorically excitable substance. The magnetocalorically excitable substance is preferably homogeneously or substantially homogeneously distributed in the starting material. The magnetocalorically excitable substance is discussed in detail below.

The apparatus comprises a working zone for receiving the starting material to be processed. A control unit is used to control all operating parameters of the apparatus. The control unit comprises a data memory for the CAD/CAM data of the 3D structure to be generated. In particular, the control unit can be formed by a computer (with an input unit, a display, an operating system and application software for controlling the apparatus). The data memory of the apparatus can, for example, take the form of an optical, electronic (semiconductor memory), magnetic or magneto-optical data memory generally known in computer technology.

The apparatus further comprises a first gradient field generator for generating a gradient field, i.e., a static or dynamically inhomogeneous magnetic field, by means of which a defined field-free space (=“field-free region”) can be location-coded in the working zone and thus in the starting material arranged in the working zone (three-dimensionally spatially resolved) on the basis of the CAD/CAM data. The field-free space is understood to be such a space in which an isolated magnetic zero field prevails.

The apparatus according to the invention further comprises a (controllable) frequency-modulable alternating field generator for irradiating an alternating magnetic field (if applicable RF field) into the working zone. This alternating magnetic field is thus used during the manufacturing process to apply energy into the starting material to be processed for the purpose of processing it. Due to the frequency modulability of the alternating field generator, it can emit alternating fields of different frequency(s).

With regard to the gradient field generator and the alternating field generator, the apparatus according to the invention and the method according to the invention described below selectively utilize a partial aspect of so-called magnetic particle imaging (=MPI imaging) in order to three-dimensionally spatially encode the location of the field-free space, which is amenable for additive or subtractive manufacturing, in the starting material to be processed and to excite the magnetocalorically excitable substance arranged in the FFR.

Magnetic Particle Imaging (=“MPI”) was developed from 2001 for medical diagnostic imaging and was first published in 2005 in “Nature” alongside MRI and CT as a further tomographic procedure for tracer-based real-time imaging (Gleich B, Weizenecker J, Borgert J. 2005, Tomographic imaging using the nonlinear response of magnetic particles. Nature. 435.7046 (2005), p. 1214-1217; DOI: 10.1038/nature03808).

MPI (magnetic particle imaging) is based on the non-linear magnetization behavior of superparamagnetic iron oxide nanoparticles (SPIONs) introduced into the body under the influence of at least two superimposed different magnetic fields. Classical applications combine the liver-specific MRI contrast agent Resovist™ with a strong static gradient field and a homogeneous alternating electromagnetic field. Along the gradient field, all SPIONs are either positively or negatively magnetically saturated, with the exception of a defined position where an isolated magnetic zero field prevails. In this so-called field-free space (FFR), the SPIONs have no or no complete magnetic saturation. In contrast to all other SPIONs outside the field-free space, they are therefore susceptible to remagnetization and magnetization, which they experience through an additionally applied alternating magnetic field.

This phenomenon is used exclusively for imaging at the MPI. This generates a signal in receiving coils that is linearly dependent on the local particle concentration, whereby the receiving coils can be identical to the transmitting coils. Digital reconstruction steps (e.g., harmonic-space or x-space algorithms) can be used to calculate position-specific spectral fingerprints in frequency space from the measurement data obtained. This allows both to assign the signals to a location and to precisely and quantitatively analyze further information about the environmental conditions of the particles in the FFR. These results can be visualized image-morphologically in 1D, 2D and 3D. In particular, they provide information about the spatial concentration distribution of the particles, but also about the temperature, binding ratios and viscosity of the particle-containing medium. The basis for this is the characteristic non-linear magnetization dynamics of the particles used, depending on the physicochemical local conditions, which can be visualized down to the molecular level by using a number of different alternating field frequencies. Even small differences in field strength can therefore shift the susceptibility of the particles into or out of the plateau-shaped region of the saturation characteristic, resulting in a more or less sharp offset in excitability. Although MPI does not enable anatomical image data acquisition, it offers an enormously high time resolution (>40 volume images per second), sensitivity (890 pg, or <100 marked cells) and an outstanding contrast-to-noise ratio without ionizing radiation. Compared to MRI, it is also 10⁴ times less susceptible to artifacts and has a theoretically unlimited penetration depth, with lower power consumption and a less demanding field generator design, which should even make mobile variants feasible.

In order to obtain data from different locations in the spatial volume, it is necessary to move the FFR across the examination volume. In the MPI, this is done by mechano-kinetic devices in at least 1 spatial axis. More elegantly, albeit in smaller dimensions, the FFR translation can also be controlled electromagnetically by superimposing other magnetic fields (drive fields or focus fields), as follows. First, the examination volume is exposed to a strong selection field, classically a strong static gradient field (0.2-7 T/m), alternatively a so-called traveling wave (see TW-MPI). The FFR defined by this can be reduced or increased by selecting the gradient strength along the gradient. An additional homogeneous (invertible) or very slowly undulating magnetic field can now shift the FFR along its plane (e.g., x-axis). Further additional homogeneous (invertible) or very slowly undulating magnetic fields in other spatial directions-ideally orthogonal to each other and to the x-axis field (i.e., y-axis or z-axis) can displace the FFR in their direction. In this way, the primarily point-shaped or ellipsoidal FFR can be navigated freely throughout space. The so-called excitation field, i.e., an additional superimposed fast alternating field (1-100 KHz; <50 mT), primarily leads to magnetization or remagnetization of the SPIONs in the FFR, with possibly relatively little influence of its field strength on the FFR position. With the help of further directionally different gradient fields-comparable to the original selection field-it is possible to modulate the geometry of the FFR in further spatial directions, e.g., linearly, and to make its offset more precise by rotation or to generate higher temporal and spatial resolutions (μm dimension). In addition, further homogeneous and inhomogeneous fields can help to optimize the precision of the process as so-called shift fields and saturation fields. These are instrumentalized and combined in an appropriate way to realize complex multidimensional trajectories on which the scanning schemes of modern imaging sequences are based.

The MPI scanner design is also constantly evolving. In addition to closed, semi-open and open systems, there are also single-sided (e.g., coplanar) and even mobile devices. Depending on the desired target parameters, these can be constructed by combining different magnetic field coils with different sizes, winding densities, geometries (e.g., ring coils according to Helmholtz or Maxwell), materials and arrangements, but also by combining them with permanent magnets or functional modules made up of smaller permanent magnet units (e.g., Halbach array), which often have rotating elements within themselves or relative to each other and can be energized both in the same direction and in opposite directions and be connected to other reactive elements.

Further detailed information on Magnetic Particle Imaging can be found in particular in: Timo F. Sattel: Scanner Topologies and Optimization of Field Sequences for Magnetic Particle Imaging (Research Series of the Institute of Medical Engineering: University of Lübeck) Infinite Science GmbH, Lücbeck 2018 (ISBN 978-3-945954-49-2).

While a static gradient field is used in MPI for location coding of the FFR, the apparatus according to the invention has a modulatable gradient field generator in this respect, which can be used to generate a gradient field that can be modulated in terms of the field strength gradient.

In contrast to the scanners used in magnetic particle imaging, the control unit of the apparatus according to the invention is set up or programmed to control the RF field generator in such a way that the magnetocalorically excitable substance of the starting material in the location-coded field-free space can be magnetocalorically excited by means of the RF irradiation in such a way that: a) in the case of a starting material comprising a prepolymer, a thermally induced polymerization of the prepolymer; and/or b) in the case of a starting material comprising a ceramic material and/or a metallic material, sintering of the ceramic/metallic material; or, c) preferably in the case of a starting material comprising a polymer material and/or a metallic material, a thermal structural decomposition of the starting material, preferably solely in the defined field-free space is triggerable or effectuable.

The system according to the invention comprises the aforementioned apparatus and the starting material to be processed with the magnetocalorically excitable substance.

The magnetocalorically excitable substance in the starting material can be magnetically saturated either positively or negatively by the gradient field.

Solely in the field-free space FFR defined on the basis of the CAD/CAM data, in which an isolated magnetic zero field prevails, does the magnetocalorically excitable substance exhibit no or no complete magnetic saturation. In contrast to the magnetocalorically excitable substance in the remaining starting material outside the field-free space FFR, this substance is therefore susceptible to remagnetization and magnetization, which it undergoes as a result of the additional alternating magnetic field that can be switched on.

The energy input of the preferably frequency-modulatable alternating magnetic field required for the polymerization/sintering or decomposition of the starting material in the FFR as well as its respective required parameterization (amplitude, frequency, duration, etc.) must be determined experimentally for the respective starting material and the respective magnetocalorically excitable substance used. The control unit is programmed to control the (frequency-modulatable) alternating field generator on the basis of this experimentally obtained data. Further details can be found below.

In summary, the apparatus, according to the invention, enables multifunctional processing of the starting material for the manufacturing of 3D structures of any geometry, structure, surface design and, depending on the respective starting material used, also with respective predefined material properties. Single and multiple post-processing procedures are possible. All this in just one process chamber.

Thus, the apparatus can be used to generate a 3D structure defined by the CAD/CAM data from the start material without contact by means of additive and/or subtractive manufacturing based on the CAD/CAM data. Furthermore, the apparatus enables postprocessing (=“post-processing”) of the 3D structure. Examples of this include microscopic and/or macroscopic surface structuring or curing of the starting material in the form of a (partially) polymerized polymer of a 3D molded body. The apparatus can be used to modulate the material properties of the 3D structure in certain areas or as a whole. The apparatus or system can also be used to coat a molded body, to join two molded bodies or to repair a damaged molded body. By using so-called self-healing plastics as a starting material, such as so-called vitrimers, 3D structures with so-called self-healing properties that were previously impossible or difficult to realize can be created or authentically repaired/healed.

According to a preferred further development of the invention, the apparatus comprises a mechanical movement device for, preferably, multi-axial, spatial movement or repositioning of the defined field-free space FFR relative to the working zone or the starting material to be arranged therein. Thus, by means of the movement device, a mechanical relative movement of the gradient field and the working zone or the starting material to be arranged therein can therefore be achieved. As a result, the field-free space FFR can be positioned at different positions, i.e., different volumes of interest (VOI), preferably along or around all three spatial axes X, Y, Z, in different positions/spatial locations for processing the starting material.

Alternatively or additionally, the apparatus can have a further magnetic field generator for generating a further magnetic field or also several further magnetic field generators for generating several further homogeneous magnetic fields (drive fields) B1, B2, B3, which can be superimposed on the gradient field in order to spatially reposition the field-free space relative to the working zone/starting material. This is undoubtedly a technically more complex solution than the aforementioned mechanical movement device but offers advantages in particular with regard to rapid repositioning of the FFR to another volume of interest (VOI) to be processed in the starting material.

If the apparatus has at least two, preferably several further magnetic field generators for generating inhomogeneous magnetic fields G1, G2, G3 ( . . . . Gn), which are preferably aligned orthogonally to each other, the geometry (=geometric shape)/size of the field-free space can be defined or varied by means of these, in particular on the basis of the CAD/CAM data. It is understood that in the case of more than 3 magnetic field generators, their magnetic fields can also be aligned at least partially at an angle of less than 90°, for example 45°, to each other. By means of such additional inhomogeneous magnetic fields, the field-free space FFR can be generated—preferably depending on the CAD/CAM data of the 3D structure to be produced—with a continuously gradable point, line, plane and volume geometry.

This enables particularly fast processing of the starting material, tailored to the size/geometry. The control unit of the apparatus is programmed to control the mechanical movement device or any other magnetic field generator on the basis of the CAD/CAM data for the 3D structure to be generated.

According to the invention, the field frequency of the alternating field emitted by the frequency-modulatable alternating field generator is between 1 KHz and 1 GHZ, preferably between 10 KHz and 1 MHz, most preferably between 100 KHz and 500 KHz. In this respect, it may be possible to speak of an RF field. At these field frequency intervals, the magnetocalorically excitable substance can be reliably magnetocalorically excited in order to ensure the polymerization/sintering or decomposition of the starting material in the defined free space.

According to the invention, the apparatus preferably has at least one imaging device, i.e., a device for obtaining image data.

The imaging device may include the following: a laser scanner; one or more CCD cameras; one or more infrared cameras; a magnetic resonance tomograph; a computer tomograph; a digital volume tomograph; a sonography device, and/or a positron emission tomograph.

The control unit of the apparatus preferably has an operating mode for obtaining and evaluating image data by means of the imaging device. This allows the apparatus to perform an imaging analysis and monitoring of the manufacturing process or of the (partially) manufactured 3D structure during the machining process, where required in real time.

If the apparatus includes an MRI, MRI-supported thermometry data can be obtained from the working zone, i.e., the starting material to be processed or the (partially) manufactured 3D structure. This thermometry data can be taken into account when creating the 3D structure, for example when determining the duration or intensity of the RF field to be applied to excite a defined voxel.

If the apparatus is set up for imaging by means of magnetic particle imaging (MPI) as described above, the distribution and concentration of the magnetocaloric excitable substance within the starting material can be measured and a sufficiently homogeneous distribution and sufficient concentration of the magnetocaloric substance in the starting material can be checked. This is advantageous for quality assurance during the production of the 3D structure. On the other hand, this makes it easier to determine the spatial distribution and quantity of the starting material to be arranged in the working zone or of the 3D structure generated in the working zone.

In additive manufacturing processes, thermodynamic phenomena are known to be an important source of artifacts, the effects of which must be controlled in the best possible way. This is to prevent both micro-dimensional losses in detail resolution and macro-dimensional structural inhomogeneities and irregularities of the 3D structure. Thermosensitive sequences in the context of so-called MRI-assisted HIFUS treatments (highly focused ultrasound) have proven their clinical practicability and reliability in the meantime. In particular, the proton resonance method is characterized by a high spatial, temporal and thermometric resolution and reliability and is therefore also suitable for monitoring the manufacturing process in order to detect unfavorable heat dissipation or accumulation in three-dimensional space at an early stage. According to the invention, the apparatus can be designed to perform such thermosensitive sequences.

The control unit preferably has a software application by means of which absolute temperature values can be determined and preferably color-coded, user-defined topographical and thermal threshold values can be coupled with alarms in a location-specific manner and compliance with precise exposure dose limits can be automated or regulated semi-autonomously using the data obtained in the thermosensitive sequences.

### Starting Material:

According to the invention, the starting material can be designed as a prepolymer (for the purpose of additive manufacturing) and comprise monomers and/or oligomers and/or polymers which polymerize by means of thermal polymerization, i.e., by the action of thermal energy.

The polymer precursor can comprise biopolymers, in particular industrially available biopolymers, preferably in purified form. These allow sustainable production of the 3D structure and are also characterized by high biocompatibility. According to the invention, polysaccharides, glycosaminoglycans, polypeptides and/or proteins, for example, come into consideration here. In particular, alginates, hyaluron, collagen/gelatine, chitosan, fibrin, silk fibroin, cellulose and even derivatives of the human extracellular matrix (ECM derivatives) and so-called (bio) artificial polymers are conceivable. Marine collagens, for example from fish waste (fish gelatine metacrolyl=FGelMa), are also conceivable.

Artificial (plastic) polymers or prepolymers in turn exhibit high mechanical stability and precisely modulable properties (e.g., defined degradation rate). These include traditional materials used in biotechnology and pharmacology, but also increasingly, established substances used in the plastics processing industry, some of which are listed below:

PLA (polylactic acid), PEG (polyethylene glycol), PCL (polycaprolactone; a very good starting material for inorganic bioceramics), PGA (polyglycolic acid), PLGA (poly (-lactide-co-glycolide), PEO (polyethylene glycol), PPO (polyphenylene oxide), PU (polyurethane), PEEK (polyether ether ketone), polyamides (nylon; +/−polyester), PCU-Sil (polycarbonate-based urethane silicones), PUU (poly-urethane urethanes), SMP (shape-memory polymers), acrylonitriles (e.g., ABS: acrylonitrile butadiene styrene), block copolymers, liquid crystal polymers e.g., ABS: acrylonitrile-butadiene-styrene), block copolymers, liquid crystal polymers.

The starting material can be selected, in particular, from the group of thermosets, elastomers, thermoplastics, vitrimers or their prepolymers.

The thermoset resin should have at least 1 thermoset functional group, e.g., epoxy group, glycidyl group, isocyanate group, hydroxyl group, carboxyl group, amide group, also, the thermoset resin may contain acrylic resin, polyester resin, isocyanate resin, ester resin, imide resin or epoxy resin.

Aromatic, aliphatic, linear or branched epoxy resins can be used, e.g., with an epoxy content of 180 g/eq-1000 g/eq with 2 or more functional groups. Such an epoxy resin can, for example, be composed of one or a mixture of 2 or more cresol novolac epoxy resins, a bisphenol A epoxy resin, a bisphenol A novolac epoxy resin, a pheno novolac epoxy resin, a tetrafunctional epoxy resin, a biphenyl-type epoxy resin, a tripheno-methane-type epoxy resin, a naphthalene-type epoxy resin, a dicyclopentadiene-type epoxy resin or a dicyclopentadiene-modified phenol-type epoxy resin.

Preferably, the epoxy resin has a cyclic structure, preferably an aromatic group (e.g., phenyl group). This enables excellent thermal and chemical stability. In particular, one or a mixture of 2 or more bipheny-type epoxy resins, a dicyclopentadiene-type epoxy resin, a naphthalene-type epoxy resin, a dicyclopentadiene-modified phenol-type epoxy resin, a creso-based epoxy resin, a bisphenol-based epoxy resin, a xylolylol-based epoxy resin, a polyfunctional epoxy resin, a phenol-novolac epoxy resin, a triphenol-methane type epoxy resin, an alkyl-modified triphenol-methane epoxy resin can be used.

In the case of a thermoset polymer or a thermoset prepolymer, this may include a monomer epoxy resin or phenolic resin or amino resin or unsaturated polyester resin, acrylic resin, maleimide resin, cyonate resin.

Thermoplastic polymers that can be considered include expanded thermoplastic polyurethane (eTPU), expanded polyamide (ePA), expanded polyether block amide (ePEBA), polylactate (PLA), polyether block amide (PEBA), polyethylene terephthalate (PET), polybutylene terephthalate (PBT), thermoplastic polyester ether elatomer (TPEE).

The starting material can also comprise at least one of the following groups: Polyamides, polyesters, polyether ketones, polyolefins. Polyamides are one or more of the homopolyamides, copolyamides, polyether block amides, polyphtalamides. Polyetherketones are one or more polyetherketones (PEK), polyetheretherketones (PEEK), polyetherketoneketones (PEKK), polyolefins are one or more polypropylene (PP), polyethylene (PE), olefin co-block polymers (OBC), polyolefin elastomer (POE), polyethylene co-vinyl acetate (EVA), polybutene (PB), polyisobutylene (PIB), as well as suitable chain extenders.

In addition, the starting material may comprise one or more of the following substances: Polyoxymethylene (POM), polyvinylidene chloride (PVCD), polyvinyl alcohol (PVAL), polylactate (PLA), polytetralfluoroethylene (PTFE), polyvinylidene fluoride (PVDF), tetrafluoroethylene (TFE), ethylene tetrafluoroethylene (ETFE), polyvinyl fluoride (PVF), perfluoroalkoxy (PFA) and thermoplastic urethanes (TPU), for example also PBT (polybutylene ternphtalate (PBT)). At least one polymeric material with epoxy groups, pyrromelletic dianhydrides, styrenemaleic anhydrides or combinations thereof can be used as a chain extender, in particular styrene-acrylate copolymers with reactive epoxy groups.

Polyamides (PA), polyether block amides come also into consideration. The chain extender is a polymer material with epoxy groups, pyromellitic dianhydrides, styrene-maleic anhydrides or a combination of these, in particular, styrene-acrylate copolymers with reactive epoxy groups, but also thermoplastic polyester-ether elastomers (TPEE). The applicable chain extender consists of at least one polymer material with epoxy groups, pyromellitic dianhydrides, styrene-maleic anhydrides or combinations thereof, in particular a styrene-acrylate copolymer with reactive epoxy groups.

Also, DGEBA epoxy, the most widely industrially processed thermoset resin for the production of epoxy and phenolic resins, which can be available as a blend with other polymer resins, is suitable. Hardener agents to be considered for an example are polyamines, aminoamides and phenolic compounds.

Vitrimers are also conceivable as new glass-like, self-healing plastics that combine the positive properties of thermoplastics and thermosets. These are characterized by easy processability in a wide temperature range and exhibit dynamic epoxy-resin transesterification under the influence of heat. In this respect, they are repeatedly moldable, easily recyclable and can be classified as “ecological plastics”. Vitrimers also close the functional gap between thermosets and elastomers in terms of their formability.

Alternatively, the starting material can also comprise vitrimer-like materials with thermally stimulable binding reversibility. These can be non-epoxy resin-based (if applicable catalyst-free). Bioplastics such as polylactide vitrimers or vitrimers made from soybean oil and citrate are also conceivable.

It should be noted that in the case of a starting material formed as a polymer material or as a prepolymer, the magnetocalorically excitable substance may be formed by the starting material itself. In other words, the starting material itself is magnetocalorically excitable.

For example, semi-crystalline polymers that absorb electromagnetic radiation (RF) to a sufficient extent, i.e., have a relatively high dielectric loss factor, which can be increased by one or more additives as required, see for example US 2016/227876 A1. It should be noted that these (directly magnetocalorically excitable) polymers must also exhibit non-linear magnetization saturation behavior for the processing or manufacturing method proposed here. In this respect, a composition of the starting material that is independent of magnetocalorically excitable particles is certainly conceivable.

In addition to the magnetocalorically excitable substance, the starting material can comprise one or more additives (=additiva). The additives can be organic and/or inorganic additives.

Metals and ceramic materials or their raw materials can be used both as starting materials and as additives.

Ceramic materials are characterized in particular by high hardness and temperature resistance and can significantly increase the wear resistance and refractoriness of products. They are divided into oxides, carbides and nitrides, preferably of the elements aluminum, tungsten, zirconium, silicon and titanium. Phosphates (biocompatible) can also be used, as well as porcelains, quartz, limes and clays. Ceramics are used both in liquid form and as viscous resins, in the form of powders, granules or filaments, whereby not only spherical but also stochastic particles of different sizes and shapes can be processed.

Metals are preferably used as starting materials in the form of spherical powders (e.g., 15-15 μm), in pure form and as individual alloys. Due to their very different properties, it is important to avoid cross-contamination during production (e.g., atomization). Particularly in connection with use in magnetic fields, a distinction must be made between magnetic metals, e.g., stainless steel (in ferritic, martensitic microstructures), as well as cobalt, nickel and iron, and non-magnetic metals. These include stainless steel (in austenitic microstructure), precious metals (gold, silver, bronze), as well as copper, titanium and aluminum and are particularly suitable for processing by means of the apparatus or method according to the invention.

According to the invention, the starting material can be in the form of a so-called “squid” (=preform). Such squids are otherwise preformed, incompletely cured polymer precursors. Thus, the 3D structure can be produced in even less time. Alternatively, the starting material can also be used to create such a “squid”.

In the case of a starting material to be thermally decomposed, this can also be one of the aforementioned polymers or a metal.

### Additives in the Starting Material:

The capacity of optional biological, chemical, physical and pharmaceutical additives should not be underestimated. These can, for example, serve as inducers, promoters, catalysts and terminators of (bio) chemical reactivity, homogenization and stabilization of the environment and thus also serve artifact reduction. Similarly, they can lead to an increase or decrease in electrical or thermal conductivity or insulation within the polymer precursor and thus positively or negatively influence the polymerization/sintering or structural decomposition of the starting material, protect sensitive internal and external zones and, where required, simplify post-processing.

Especially with a starting material in the form of a prepolymer the additives can be in particular from the group of: fibers (e.g., carbon filaments, glass fibers); colorants; antibacterial substances; growth factors; nanoparticles/tubes; mineral fillers (e.g., tricalcium phosphate cement, nano-hydroxyapatite, bioactive glass); metallic materials (e.g., silver, gold, magnetites (Fe2O3, Fe3O4)—e.g., SPION=superparamagnetic iron oxide nanoparticles, Gd chelates/conjugates); glycosaminoglycans; so-called MMC substances (for so-called macromolecular crowding; e.g., dextrans or ficol (=sucrose-epichorhydrin copolymer)); polypeptide motifs such as -RGD sequences (arginine, glycine and aspartic acid), which occur, for example, in proteins of the extracellular matrix (e.g., in fibronectin and vitronectin); -IKVAV+-YIGSR (laminin); promoters, terminators, inhibitors and catalysts; sensitizer; and immunomodulators (such as VGF or the JNK3 molecule)

### Magnetocaloric Substance:

The term magnetocaloric substance refers to all excitable chemical elements, substances and compounds or chemical groups that can be excited by an alternating magnetic field with the release of heat.

According to the invention, on the one hand particles are suitable as magnetocaloric substances.

Both microparticles with a maximum particle size between 1 μm and 1000 μm determined by sieving or by laser diffraction or dynamic light analysis and/or nanoparticles with a maximum particle size between 1 nm and 100 nm determined, for example, by SEM microscopy or field flow fractionation or small-angle X-ray scattering here come into consideration. The nanoparticle concentration in the starting material is preferably less than 5% by weight and the microparticle concentration in the starting material is preferably less than 15% by weight.

The particles used can be paramagnetic (nano) particles, ferromagnetic particles, ferromagnetic filaments and/or fibres, magnetosomes, magnetosome chains, synthetic or functionalized ceramic particles, carbon-based susceptors, synthetic microspheres (carboxylated superparamagnetic microspheres (manufacturer: Magnefy™). The particles can, for example, consist of magnetite (Fe₃O₄) or a silver halide (AgₙXₙ).

The magnetosomes mentioned above have nanoparticulate magnetite particles or greigite particles (Fe3S4) and are found in certain bacteria and fungi. These magnetosomes formed by biomineralization are characterized by a particularly small dispersion of the average particle size of their nanoparticulate particles. In the context of the invention, such magnetosomes, preferably purified or where applicable with the prokaryotic/eukaryotic cells in which the magnetosomes are contained, can be used as a magnetocalorically excitable substance. Although the known magnetosomes comprise nanoparticles of an intrinsically ferromagnetic material, below a size of about 50 nm the nanoparticles exhibit paramagnetic or superparamagnetic properties. See e.g., Manucci S et al (2018) Magnetosomes extracted from Magnetospirillum gryphiswaldensae as theranostic agents in experimental model of glioblastoma. Contrast Media Mol Imaging Jul. 11, 2018:2198703. doi: 10.1155/2018/2198703. Heinke D et al (2017) MPS and MRI efficacy of magnetosomes from wild-type and mutant bacterial strains. Int J Mag Part Imag Vol 3 No 2 (2017), pp. 1-6) Article ID 1706004

It should be noted that in the case of a starting material comprising a prepolymer or a polymer, in particular, a plastic polymer, the nanoparticles or microparticles can influence both the viscosity of the polymer and the material properties of the 3D structure to be produced from the starting material. Depending on the selection of the particles used in the starting material, the mechanical strength, electrical conductivity and/or the resistance of the 3D structure to chemically or abrasively aggressive substances can be adjusted as required. The magnetocaloric substance is preferably homogeneously distributed in the starting material. Thus, in the case of a starting material formed as a prepolymer (i.e., polymer precursor comprising one or more polymers, copolymers and/or monomers and/or dimers, etc.), the magnetocaloric substance can be at least partially or completely bound to monomers/polymers. Such metal organyls or organometallic compounds generally have a polar covalent bond between a carbon atom and at least one metal or electropositive element atom.

However, an inhomogeneous distribution of the magnetocaloric stimulable substance in the starting material is also conceivable, whereby different material properties of the 3D structure to be produced can be set in areas with a higher density of the magnetocaloric substance, as mentioned above, than in areas with a comparatively lower density of the magnetocaloric substance.

The concentration of the magnetocalorically excitable substance or particles is preferably >100 particles per milliliter of the starting material, in particular >10,000 particles per milliliter of the starting material. This ensures reliable and homogeneous polymerization/sintering/decomposition of the starting material during the processing/manufacturing process. The concentration of the particles can be adjusted as required depending on the 3D structure to be produced from the starting material. According to the invention, the concentration of the magnetocaloric excitable particles can be up to 10¹⁷ particles per milliliter of the starting material. This means that even the smallest 3D structures can be additively manufactured with a previously unattainable resolution of detail.

It is understood that the starting material can also have more than one magnetocalorically excitable substance, which differ at least partially from one another in their material properties or in their specific chemical composition and/or size.

With regard to the biocompatibility of the magnetocaloric substance and in order to stabilize its dispersion in the starting material, it can be coated with titanium or another biocompatible material, such as polyetheretherketone (PEEK), polyetherimide (PEI), polycarbonates, acrylonitrile-butadiene-styrene, polylactides (PLA), polyhydroxyacetic acid, polyglycolic acid.

The thermogenicity of the magnetocaloric excitable substance used is essentially attributable to three main mechanisms, including Néel relaxation, Brown relaxation and hysteresis loss effects.

The following laws apply to the magnetocaloric excitable substance: the larger the particles, the greater their heating effect when excited; the larger the particles, the lower the field strength required for saturation magnetization; the larger the particles, the greater the required alternating field amplitude required for remagnetization; the larger the particles, the smaller the FFR; the greater the magnetic field gradient, the smaller the FFR; the higher the alternating field strength, the faster the temperature rise; the higher the field frequency of the magnetic field used for excitation, the greater the heating effect of the particles with increasing hysteresis dominance; in the case of a magnetocaloric substance comprising nanoparticles, nanoparticle aggregation in the starting material can increase the heating effect (internal dipole interaction); the larger the particles, the less superparamagnetic they are; the larger the particles, the more Brown relaxation; the larger the particles, the more hysteresis loss effects; the smaller the particles, the more Neel relaxation; and the greater the distance of the particle to the FFR center, the lower its heating power.

It should be noted that the influence of the shape, isomorphism, crystal structure and size of the magnetocaloric substance or magnetocaloric particles on their distribution quality, i.e., the tendency to migrate and aggregate and to migrate undesirably in the magnetic field, decreases with increasing viscosity of the surrounding medium, i.e., the residual starting material (e.g., resins) with fast magnetic field switching.

### Alternating Magnetic Field:

The energy input into the field-free space of the starting material to be processed by means of the (frequency-modulatable) alternating field can be influenced by the following factors: modulation of the amplitude of the alternating magnetic field (“=excitation field”); and the location-specific excitation duration of the alternating magnetic field defines the heat generation.

Experimentally, a maximum of 2400 W/g (when using magnetospirillum as a magnetocaloric substance; at a field frequency of 200 kHz and a magnetic flux density of 38 mT) could be achieved (=300×10⁵-6×10⁶ times the FDA limit for diagnostic energy transfer by electromagnetic fields to human tissue. This corresponds to 573° C./gs

Using magnetosome chains (d: 20/23 nm; I: 140 nm; 300 kHz) and a magnetic flux density of 15 mT, more than 1250 W/g could be achieved. In this regard, reference is made to the publication Application of Magnetosomes in Magnetic Hyperthermia Nikolai A. Usov 1,2,3,* and Elizaveta M. Gubanova 3. Nanomaterials. Nanomaterials 2020, 10, 1320; doi: 10.3390/nano10071320.

### Resolution Capacity:

The resolution of the apparatus or the manufacturing process is directly dependent on the spatial extent of the field-free space.

Theoretical influencing factors here are FWHM/gradient strength (T/m) (FWHM in the derivative of the Langevin function assumed as the characteristic curve of the saturation magnetization): gradient strength (if applicable non-linearity); field dynamics (c TWMPI; rotation); additional fields (saturation, cancelation); and non-linearity of particle saturation magnetization (size, shape, surface, crystallization, aggregation status, shell).

In principle, the heating power of the magnetocalorically excitable substance or magnetocalorically excitable particles outside the FFR decreases increasingly sharply. This creates a small offset field around the FFR, which can be regarded as the “penumbra” of the FFR.

While a reduction in the detail resolution during the production of the 3D structure is due to blurring of the polymerization boundaries, which occurs as a result of thermodynamic heat conduction exceeding the FFR during manufacturing, macro-dimensional aberrations based on coarse heat accumulations only become apparent after the end of polymerization/sintering or decomposition of the starting material, resulting in shrinkage and distortion due to material relaxation during cooling. Experience has shown that these phenomena are less pronounced with induction heating than with other thermal curing processes and can be further reduced by preheating the starting material and, if necessary, postheating the 3D structure.

With that in mind, the apparatus can have a temperature control device for controlling the temperature of the working zone or the starting material arranged/to be arranged in the working zone. By means of the temperature control device, the polymer precursor can be cooled as required, e.g., in order to counteract undesired uncontrolled polymerization of the starting material outside the field-free space before and/or during the manufacturing of the 3D structure. The temperature control device can also be used to heat, i.e., “to temper”, the working zone or the starting material arranged therein, if required, in order to facilitate its processing.

Tempering, i.e., preheating, the starting material serves both to mitigate the temperature gradients and homogenize the temperature profile in general, as well as specifically to reduce the amount of energy to be inductively applied and thus to reduce the risk of aberrant thermal dynamics at micro and macro level. This can be understood as a preconditioning of the starting material. The clearer and more narrowly defined the transition threshold is, the clearer the technical selectivity. In addition, the lower the thermal conductivity of the starting material used, the lower the risk of heterotopic heat accumulation and thus dystopic polymerization/sintering/decomposition of the starting material, i.e., the higher the thermal and consequently the structural resolution capacity.

In order to avoid macrodimensional as well as microdimensional heat accumulations, the generation of large differences in solidity and volume, concentrated material masses, strong caliber jumps and strong temperature differences in the 3D structure to be generated should be avoided. On the other hand, the resolution capacity within the starting material increases with the steepness of the temperature gradient between heated FFRs relative to their surroundings, which is why cooling measures should even be considered at relevant boundary zones, functional reliefs and edges to optimize details. A certain stimulation redundancy of the magnetocaloric substance or inertia of the polymerization/sintering/decomposition of the starting material can also reduce the susceptibility to thermal artifacts in favor of the structural resolution capacity. Thus, in the multi-shot concept, several stimulative alternating magnetic field pulses are necessary to reach the transition temperature, strictly matched to the thermal conductivity of the starting material, resulting in a steeper temperature gradient to the respective volume areas of the starting material adjacent to the FFR and thus a higher selectivity.

With increasing curing of the polymer/sintered starting material, the structural conditions change with a considerable influence on heat dissipation. Zonally varying material continuity and solidification result in an increasingly heterogeneous thermal system as curing progresses, in which accumulation effects result in the coexistence of overheated and undercooled zones, which should be prospectively taken into account and proactively compensated for in order to avoid dystopic polymerization/sintering/decomposition optimally. This can be achieved, taking into account all the phenomena described and all the influencing factors mentioned, by selecting a suitable thermoresponsive starting material with an appropriate position of the thermal transition threshold and advantageous thermal conductivity (see above) on the one hand, but in particular by targeted modulation of the pulse duration and intervals of the exciting alternating magnetic field on the other hand. Thus, a longer continuous local excitation leads to a steeper temperature gradient than a repetitively repeated short, impulsive excitation, and the sequential excitation of two immediately adjacent spatial volumes of the starting material leads in sum to a locally higher heat accumulation than the stimulation of two distant spatial volumes.

According to the invention, the working zone of the apparatus can be arranged within an enclosure or housing of the apparatus. As a result, a defined working environment for generating the 3D structure can be provided and maintained. For example, the temperature, the composition of the atmosphere (=working atmosphere), the atmospheric pressure in the working zone and also the humidity of the working atmosphere directly surrounding the working zone can be adjusted as required in a simplified and cost-effective manner. The enclosure can be made of plastic, for example in the form of a plastic film, glass or another suitable material.

In particular, the temperature control device can also be used for controlled cooling of the starting material/3D structure. For example, cold air and/or a suitable cooling liquid, such as water, can be supplied to the starting material/3D structure via the temperature control device. This can counteract the formation of undesirable damage, in particular stress cracks, in the 3D structure. It is particularly preferable for the apparatus to have a pump by means of which the working zone can be filled with a working atmosphere specified for the respective manufacturing process or a subatmospheric pressure or approximate vacuum can be built up in the working zone. This also makes it possible to smoothen the surface of the 3D structure, for example by vapor (so-called “vapor smoothening”), or to disinfect/sterilize the 3D structure directly in the working zone.

### 3D Structure:

The 3D structure that can be manufactured using the apparatus can be any product. For example, the 3D structure can be a machine element. In particular, axles, shafts, bearing elements, gear parts, sealing elements, connecting elements, housing (parts), etc. can be considered here. In particular, the 3D structure can also be a bonded, soldered or welded joint between two or more components or a coating on a component. The 3D structure to be produced from the starting material can, for example, consist of an elastomer, a thermoplastic or a thermosetting polymer or comprise one of these materials.

The 3D structure can also be a medical product, for example, an epithesis, an orthosis, a bandage, a brace, a dental veneer, a respiratory tube, a tissue adhesive, a medical implant or a (bio-) artificial structure for tissue or organ replacement. In addition, the 3D structure can be an everyday object, such as jewelry, a watch case, a toy, a carrying container, tableware or cutlery.

Conceivable in-situ processing of the metallic, ceramic and/or a plastic polymer containing starting material or formed by such for manufacturing a 3D structure is plausible. This would allow all the advantages of natural tissue regeneration within a physiological, bioresponsive environment to be exploited right from the start. Cardinal problems of traditional tissue replacement products and conventional bioreactors, such as lack of stability, lack of integrativity, lack of adaptivity, lack of interactivity and insufficient vitality could be overcome.

The apparatus according to the invention holds the key to universality and the enormous potential to produce a 3D structure that is highly flexible and individualized at both the microtopographic and macroarchitectural level to meet the diversity of tissue defects and recipients in need of therapy. The apparatus can be used to produce a 3D structure that authentically reproduces the natural anisotropy of hierarchically organized biological tissues and the deterministic complexity of bioartificial interfaces in order to create the biomimetic basis for the long-term functionality of the implant in the overall systemic network at the earliest possible time and in a sustainable manner. For example, the apparatus or system according to the invention can be used for the in-vivo fabrication of the 3D structure. Here, a seamless connection of the 3D structure to be generated with the body's own or foreign structures, i.e., their anchoring at the target site with the surrounding tissue, can be realized. The apparatus thus enables direct in-situ 3D bioprinting in the living organism. The optional vitalization of the 3D structure through passive and/or active cell colonization, for example, can be realized in a contactless and minimally invasive manner.

If the apparatus has at least one or more of the aforementioned devices for image (data) acquisition, this enables image-controlled or image-navigated application of the starting material at the predefined target location. This is particularly advantageous for the in-vivo fabrication of the 3D structure. It should be noted that when used in the medical field, the apparatus according to the invention enables 8D production of the 3D structure in the broader sense. In other words, a technology that can “add” material in all spatial directions without axes (“real” 3D). During in-vivo fabrication, the 3D structure can interact with its environment (4D), instruct it (5D), be vitalized by cells (6D) and thus be adaptable up to complete biological integration (7D), but can also be modified externally without contact and, if necessary, for several times (8D). It should be particularly emphasized here that “real” 3D processing guarantees a homogeneous isotropic—i.e., uniform—load-bearing capacity of the 3D structure, whereas classic 3D printed products generally have a direction-dependent mechanical load-bearing capacity depending on the traditional build-up axis (z-axis).

In the medical context, the apparatus according to the invention or the 3D method according to the invention can be used to repair, reconstruct, respect, correct and optimize the integrity and interactivity of functional anatomical structures in order to stimulate and amplify authentic regenerative processes. This applies in particular, to very small anatomical functional units and very large tissue volumes, which have so far eluded sufficient “restitutio ad integrum” using conventional techniques.

In contrast to the established traditional methods of contactless energy transfer by means of UV/IR radiation, ultrasound or laser, electromagnetic induction displays—neither for increasing travel paths in the polymer precursor and/or in the tissue (penetration depth) nor at material transitions—relevant undesired interference and absorption phenomena. In addition, electromagnetic induction does not have a biologically damaging potential within legal dose limits and frequency spectra; and no protective atmosphere or rigid, mechanical guide systems are required per se. It is therefore to be regarded as an ideal energy source for contactless in vitro and also in vivo biofabrication.

The method according to the invention for producing a 3D structure by processing a starting material using the aforementioned system can be referred to as magneto selective manufacturing (=MSM). The method comprises the following steps: defining (102) CAD/CAM data (40) for the 3D structure (30) to be produced; a) providing (104) a starting material to be processed, which comprises a magnetocalorically excitable substance distributed, preferably homogeneously, within the starting material; b) introducing (106) the starting material into the working zone of the apparatus (12); c) spatially encoding (108) a first field-free region within the starting material as a function of the CAD/CAM data (40) by applying at least one gradient field; d) magnetocaloric excitation of the substance in the field-free region by superimposing an alternating magnetic field in such a way that the starting material, preferably solely in the field-free region, is thermally induced polymerized or sintered or is thermally structurally decomposed.

The starting material arranged in the FFR is thus heated by irradiation of the alternating magnetic field and the associated magnetocaloric excitation of the substance, and thereby, in the case of: a starting material, which is designed as a prepolymer, polymerized; a metallic or ceramic starting material, sintered; the case of a polymer material or that of a metallic starting material, thermally induced decomposed.

The additive/subtractive manufacturing process proposed here allows the 3D manufacturing of any 3D structures of any geometry, configuration and complexity-depending on the starting material used, also of any consistency-individually in vitro and, where appropriate, also in vivo. The strategy of building structures from the smallest possible subunits results in a maximum freedom of design and adaptability of the method. This is possible with detailed accuracy and speed that was not possible until now. The method can enable new routes for the production of machine elements, medical products, in particular in medical and biotechnological biofabrication, and even in the case of in situ bioprinting. This is especially so because the MSM method according to the invention enables a precise surface design and a seamless linkage or anchoring with other structures. This can foster simplified and more reliable vitalization through passive/active cell colonization when the 3D structure is implanted. In the medical context, the MSM proposed here can enable the creation of implants that repair, reconstruct, respect, correct and optimize the integrity and interactivity of functional anatomical structures in order to stimulate and amplify natural regenerative processes.

In contrast to the established traditional methods of contactless energy transfer using UV/IR radiation, ultrasound or LASER, electromagnetic induction does not exhibit any undesirable interference or absorption phenomena with increasing distance in the polymer precursor or tissue (penetration depth) or at material transitions. In addition, electromagnetic induction does not have any biologically harmful potential if legal dose limits and frequency spectra are observed, does not require a protective atmosphere or rigid mechanical guidance systems per se and can therefore be regarded as an ideal energy mediator for contactless in vitro and in vivo biofabrication.

The MSM method according to the invention now offers for the first time a practicable approach to how inductive energy depositions by means of non-directional alternating electromagnetic fields (RF field) can be locally-specifically realized, modulated and used for controlled additive and subtractive structure manufacturing in a targeted manner.

The particular appeal of the method according to the invention lies in the subtle, multi-parametric controllability of the step-by-step build-up phases of the product structure in real time, resulting in maximum process control, customizability and quality of outcomes.

For processing the starting material in different spatial areas, the method according to the invention has the following further steps: f) location coding of a further, field-free region in the starting material depending on the CAD/CAM data of the 3D structure to be generated using the gradient field; and g) magnetocaloric excitation of the magnetocalorically excitable substance in the further field-free region by superimposing an alternating field in such a way that the residual starting material in the field-free region is thermally induced polymerized or sintered or is thermally structurally decomposed.

According to the invention, spatially encoding the further field-free region can be done by moving the starting material and the gradient field relative to each other by means of a mechanical adjustment device of the system or by superimposing one or more further magnetic fields on the gradient field, preferably each in the form of a homogeneous magnetic field. Advantageously, the relative movement can take place along/around all three spatial axes X, Y, Z.

According to the invention, the size and/or geometry of the respective field-free region can be defined, i.e., predetermined, depending on the CAD/CAM data of the 3D structure to be generated by superimposing the gradient field with one or more further inhomogeneous magnetic fields. These magnetic fields can be referred to as zoom or focus fields. This can accelerate the production of the 3D structure and, where required, counteract the formation of tension damage.

A particularly high dimensional accuracy of the 3D structure to be generated can be achieved by obtaining image data on the starting material and/or on the partially generated 3D structure, preferably at intervals, by means of an imaging device of the apparatus, and the further manufacturing process is carried out taking this image data into account, whereby, if necessary, in further steps the image data is compared with the CAD/CAM data; and the CAD/CAM data for the 3D structure is altered on the basis of the image data if a defined permissible maximal deviation of the image data from the CAD/CAM is exceeded.

According to the invention, the frequency/phase position/amplitude of the alternating magnetic field is/is to be tuned to the characteristic optimum frequency for the desired/appropriate thermal output of the magnetocalorically excitable substance to be excited and to the viscosity of the starting material solely in a respectively addressed VOI or FFR under given magnetic saturation conditions outside the FFR. If the apparatus is set up for MPI imaging, the viscosity in the starting material can also be determined in real time using the color MPI method.

According to the invention, the intervals between the irradiations of the alternating magnetic field (e.g., HF pulse (pulse periodicity)) are defined as a function of the following factors: thermogenicity (=characteristic power consumption+thermal efficiency) of each individual oscillator or their thermogenic sum/voxel; thermal transition threshold(s) of the polymer precursor or mineraloids/ceramics; thermal conductivity of the polymer, mineraloid or metal or its precursors; polymerization kinetics or sintering kinetics or decomposition kinetics (material-specific/architectural-specific);

polymerization pattern or sintering pattern or decomposition pattern (see CAD); e.g., degree of resolution, thermal bridges/heat-accumulating subunits (spatial pulse density, temporal pulse density); (=modulation of the energy input via temporospatial pulse algorithms); where necessary, pulse amplitude/angle of incidence with respect to the voxel to be excited.

The interval periodicity or pulse train length of the alternating field (or RF-) stimulation is primarily defined by the thermodynamic effects in the predefined setting, potentially limited by the maximum speed of the control unit+magnetic field generators to switch between 2 precise 3D FFR-voxel isolations (“indirect focusing”).

According to the invention: in principle, virtually any interval between the individual pulses of the RF radiation can be present, provided that the voxel-specific or VOI-specific (volume of interest) energy input individually or as a sum causes the desired thermal effect in the voxel/VOI; for a maximally fast voxel (or VOI) resonance isolation (target coding), a continuous RF radiation (RF pulsation) is theoretically also possible, since in principle only those oscillators oscillate thermogenically for which appropriate saturation conditions prevail; for an in vivo production of the 3D structure, a fractional pulse algorithm, for example with repetitive RF radiation cycles, is possible, which is advantageous under thermodynamic aspects and allows minimization of the global RF- and thus energy-irradiation into biological tissue.

According to the invention, the frequency of the RF radiation irradiated into the working zone can basically lie in the kilohertz to terahertz range. The frequency of the RF radiation irradiated into the working zone can in principle be between 1 KHz and 1 GHz, preferably between 10 KHz and 1 MHz, particularly preferably between 100 KHz and 500 KHz.

The control unit of the device serves the following tasks: a) system control/monitoring; b) data management; c) CAD unit; d) image acquisition/analysis/reconstruction. It goes without saying that the control unit can have application software with Al properties.

After printing the 3D structure, the method according to the invention can comprise the further step of postprocessing of the 3D structure. Thus, the 3D structure as a whole can be kept at a predetermined temperature over a defined period of time and/or cooled as a whole in a predetermined manner, in particular stepwise. In the former case, any necessary “post-maturing” of the 3D polymer structure, i.e., complete polymerization of the entire 3D structure, in particular after removal of excess prepolymer, can be achieved. The heat input required for this can be achieved, for example, without prior spatial encoding of individual voxels by irradiating the 3D structure with HF radiation or by applying infrared radiation and/or supplying hot air.

To cool the entire 3D structure, the aforementioned active heat input into the 3D structure can be reduced, e.g., gradually, over time or the 3D structure can be cooled in a controlled manner by actively removing heat, for example by supplying a cooling medium (e.g., air or water). This can prevent undesirable stress cracks and the like in the 3D structure.

### Use of the Apparatus/System:

The above-explained apparatus or the system or the starting material with the magnetocaloric excitable substance can be used universally in the field of technology and also in medicine. Thus, they can be used or employed, for example, to produce a medical implant, in particular a bone substitute, a scaffold for an organ or tissue, or a vascular prosthesis.

### Individual Possible Uses of the Invention are Given Below:

Plastic radiology: stabilization of tissue/the creation of spacers; reconstruction of tissue/tissue replacement; adaptation/anchoring/embolization; augmentation/contouring/enhancement of tissue; compartmentalization/encapsulation, for example of pathological processes.

Reparative & Reconstructive Radiology: In addition to the specific replacement of connective and supporting tissues (cartilage, bone, tendons, ligaments, intervertebral discs), the apparatus/system/is suitable both for plastic reconstruction, functional and aesthetic shaping and shape correction as well as for diffuse tissue stabilization in the case of primary and secondary reduced tissue tone.

The apparatus/system can be used to create a 3D structure: as a binding agent in fracture zones and arthrodesis; as an adhesive for the treatment of acute wounds and as a bioactive protector for chronic wounds; as a mesh substitute in hernioplasty and as a placeholder; a lead structure and carrier material for cellular structures and/or acellular additives and active agents.

Furthermore, the invention allows the synthesis, anatomization, stabilization, adaptation and occlusion of cavities in vivo, including valve, sphincter and shunt systems, largely independently of their dimensions, configuration and position. For the first time, this promises individualized curative strategies for a large number of previously unsatisfactorily treatable chronic diseases such as PAOD, lymphedema and chronic venous insufficiency, but should also significantly improve the outcome of classic (microvascular) flap plasties and limb-replantations.

The invention can be used for gentler and at the same time more efficient anchoring of an implant, in particular a joint endoprosthesis. In the event of wear, the apparatus and the polymer precursor can be used in vivo to recoat the endoprosthesis. The invention can also be used to generate a large- or full-surface bioartificial cartilage replacement in situ.

### Captive Radiology:

The apparatus/system/polymer precursor can be used to avert danger and limit complications of tumorous and inflammatory diseases by sealing off affected anatomical compartments by means of the 3D structure. This allows such pathological processes to be treated inside an isolated “neoanatomical” space, e.g., chemo- or immunotherapeutically, radio-oncologically or thermally- or to be palliatively confined.

Since the metastasis probability increases with increasing tumor surface area, even an incomplete encasement of tumors by means of the 3D structure generated in vivo is likely to be associated with a prognostic benefit. The artificial polymer sheath can also serve as a guiding structure for a biopsy, as an orientation aid during tumor resection, as a solidified safety margin and quite generally as a spacer or protective shield for vulnerable structures.

### Manufactive Radiology:

The apparatus/system or polymer precursor can be used for the in vivo manufacturing of 3D structures in the form of guide elements, anatomical (e.g., electroconductive) guidewires and polymer 3D rail networks, as well as bioartificial sensor technologies and conductor systems. This can further advance the emerging automation of medical therapy and diagnostics, for example by (partially) autonomous miniature robots used intracorporeally, soft robots or, in particular, intracorporeally, portable electronic devices.

During the manufacturing process, at least some of the voxels/volumes of interest defined on the basis of the CAD/CAM data can be modified in terms of their spatial position in the working zone, their size and/or their geometry for the manufacturing process on the basis of image data acquired, in particular by magnetic resonance imaging. The manufacturing tolerance of the 3D structure can therefore be further improved.

Depending on the imaging unit used, the manufacturing process does not need to be interrupted in order to collect suitable image data from the working zone, in particular from the starting material or the 3D structure already created (or the environment adjacent to the 3D structure). The image data can, in particular, be collected and acquired depending on CAD/CAM data of the 3D structure to be produced.

According to the invention, the image data is preferably compared with the CAD/CAM data and, if a deviation of the already (partially) manufactured 3D structure is detected, the CAD/CAM data for generating the remaining 3D structure is modified on the basis of the image data. In this way, an exceptionally small manufacturing tolerance of the 3D structure can be realized.

Further advantages of the invention arise from the description and the drawings. The embodiments shown and described are not to be understood as an exhaustive list but rather have an exemplary character for the description of the invention.

### BRIEF DESCRIPTION OF THE DRAWINGS

FIG. 1 is the schematic structure of a system according to the invention with an apparatus and with a starting material that can be arranged in the working zone of the apparatus and from which a predetermined 3D structure is to be produced;

FIG. 2 is the source material in the gradient field of the apparatus presenting a dot-shaped field-free space within the source material;

FIG. 3 is the starting material in the gradient field of the apparatus presenting a linear field-free space within the starting material;

FIG. 4 is an enclosure within which the starting material is arranged during the 3D manufacturing process; and

FIG. 5 is a block diagram of the method according to the invention for generating a 3D structure with individual procedural steps.

### DETAILED DESCRIPTION OF EMBODIMENTS OF THE INVENTION

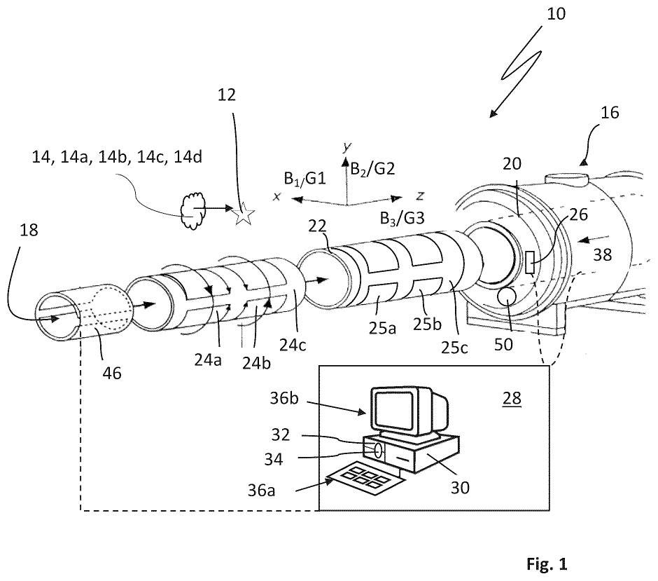

FIG. 1 is a system 10 for manufacturing a 3D structure 12 by processing a starting material 14 comprising a magnetocalorically excitable substance on the basis of CAD/CAM data of the 3D structure 12.

The system 10 comprises an apparatus 16 with a working zone 18 for receiving the starting material 14.

A gradient field generator 20 serves to generate a gradient field, preferably one that can be modulated. The design of the gradient field generator 20 can be tubular, as shown in FIG. 1, so that the starting material 14 to be processed can be introduced frontally into the working zone 18 of the apparatus 16 and the 3D structure 12 produced from it can be removed frontally from the working zone 18 of the apparatus 16. Alternatively, the magnetic gradient field generator 20 can also have a so-called open design in order to allow lateral access to the working zone. The field strength of the magnetic gradient field is a power greater than the earth's magnetic field. It should be noted that the gradient field is spatially variable in terms of its field direction and/or temporally variable in terms of its field strength.

The apparatus 16 additionally comprises at least one frequency-or amplitude-modulatable alternating field generator 22 for radiating an alternating magnetic field (RF field), which can thus be frequency-modulated, into the working zone 18. The alternating field generator 22 is used for the energy input into the working zone 18 required for the three-dimensional position-coded processing of the starting material 14.

The gradient field generator 20 serves to generate a field-free space (=FFR) at a defined position (VOI) in the starting material 14 arranged in the working zone 18 and to magnetically saturate the magnetocalorically excitable substance of the starting material 14 outside the respective FFR. As a result, solely or essentially solely the magnetocaloric substance of the starting material 14 arranged in the FFR is magnetocalorically excitable by the alternating magnetic field emitted by the alternating field generator 22.

The apparatus 16 further comprises several more, here three, magnetic field generators 24a, 24b, 24c, by means of which in each case a homogeneous magnetic field B1, B2, B3 can be superimposed on the gradient field in the working zone each in the direction of one of the three spatial axes X, Y, Z. The field-free space FFR generated by the gradient field generator 20 can be moved along all three spatial directions X, Y, Z relative to the working zone 18 and thus relative to the starting material 14 to be processed by (controlled) superimposition of the aforementioned homogeneous magnetic fields B1, B2, B3.

Alternatively or additionally, the apparatus 16 can have a mechanical movement device 26 in order to mechanically adjust the working zone 18 together with the starting material 14 arranged therein and the gradient field, relative to one another, preferably multiaxially. This allows a different VOI of the starting material 14 to be detected by the FFR and processed.

A control unit 28 with a computer system 30, a memory 32 with CAD/CAM data 34 stored therein for the 3D structure 12 to be manufactured and with an input and operating console 36a and a display 36b serves to control all operating parameters of the apparatus 16.

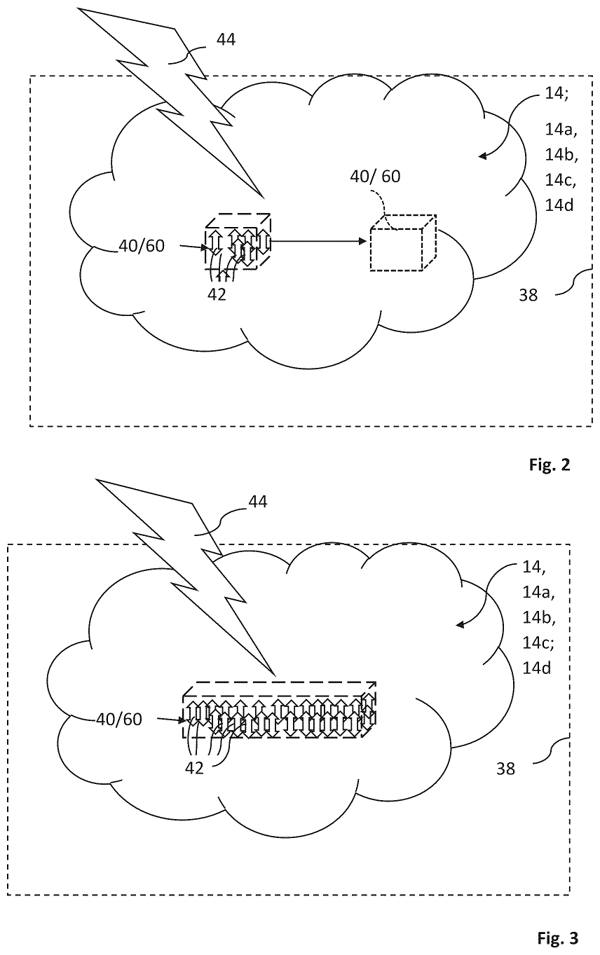

In FIGS. 2 and 3, the starting material 14 is shown within the gradient field 38 of the apparatus. The FFR 40 defined by the gradient field 38 is native, i.e., without superimposition of further magnetic fields, punctiform as shown in FIG. 2 and can be linear by superposition of two gradient fields 38 as shown in FIG. 3.

By superimposing one, two or three inhomogeneous magnetic fields G1, G2, G3 generated by the magnetic field generators 25a, 25b, 25c, the geometry and size of the FFR can be varied on the basis of the CAD/CAM data of the 3D structure in a manner suitable for manufacturing the 3D structure 12.

The starting material 14 can, for example, be a prepolymer 14a. The prepolymer 14a may comprise the same or different monomers, dimers, oligomers or polymers. Furthermore, the prepolymer may comprise fibers and/or one or more other additives. Depending on the mechanical, electrical or biological demands on the 3D structure, the prepolymer may, for example, have a viscosity of about 102 mPa-s to 105 mPa-s or greater.

The starting material 14 can also be a metal 14 in powder or granular form, or a ceramic material (=ceramic precursor) 14c in powder or granular form, or a preform 14d. A preform is understood to be a—where appropriate only partially polymerized-3D moulded body made of a polymer material or a 3D moulded body made of a metal or ceramic material.

The magnetocalorically excitable substance 42 can in particular be in the form of particles, such as nano- or microparticulate metal particles (=nano-oscillators). In particular, the metal particles may consist of nanoparticulate magnetite (Fe₃O₄). In the gradient field, the maximum possible magnetization of the magnetocaloric substance 42 is reached outside the FFR. There, the magnetocaloric substance 42 is subject to so-called magnetic saturation. The magnetocaloric substance is preferably homogeneously distributed in the starting material 14. The magnetocaloric substance 42 arranged in the FFR 40 of the gradient field 38 can be excited by the alternating magnetic field 44 that can be generated by the frequency-modulatable alternating field generator 22. When exciting the magnetocaloric substance 42, its thermogenicity can essentially be attributed to three main mechanisms, including so-called Néel relaxation, Brown relaxation and hysteresis loss effects.

The control unit 28 or the computer system 30 of the apparatus 16 is programmed to control the frequency-modulatable alternating field generator 22 in such a way that the magnetocalorically excitable substance 42 of the starting material 14 can be excited in the field-free space spatially encoded by the gradient field 38 by means of the alternating magnetic field 44 generated by the alternating field generator 22 in such a way that, in the case of a starting material 14 comprising a prepolymer, thermally induced polymerization of the prepolymer to form a polymer; and/or, in the case of a starting material comprising a ceramic material and/or a metallic material, sintering of the ceramic/metallic material or, in the case of a starting material designed as a preform, thermal structural decomposition of the starting material is triggered, preferably solely, in the defined field-free space FFR 40.

It goes without saying that the energy input of the alternating field for magnetocaloric excitation of the magnetocalorically excitable substance 42 in the starting material 14 arranged in the field-free space required for thermally induced polymerization/sintering or structural decomposition of the starting material 14 respectively, must be specifically matched to the material properties of the starting material 14 and of the magnetocaloric substance 42 incorporated in the starting material 14. This is to be determined experimentally and the alternating field 44 must be defined accordingly with regard to its amplitude, frequency and pulse duration. The experimentally obtained data are advantageously stored in the memory 32 of the control unit 28. The field frequency of the alternating magnetic field 44 for exciting the magnetocalorically excitable substance 42 is in any case between 1 KHz and 1 GHZ, preferably between 10 KHz and 1 MHZ, most preferably between 100 KHz and 500 KHz.

The apparatus 16 preferably has an imaging unit 46 for obtaining image data from the working zone 18. The imaging unit can comprise an MRI device, a computer tomograph, a CCD camera, an infrared camera, whereby the control unit 28 is set up to compare these image data with the CAD/CAM data 34 of the 3D structure 12 and, if in particular geometric discrepancies, between image data and CAD/CAM data 34 are detected, to take the image data or the deviations into account in the further manufacturing process, whereby the control unit 28 is set up to change the CAD/CAM data 34 on the basis of the (obtained) image data. In the latter case, the use of artificial intelligence or a software application with Al capability stored in the control unit can be advantageous, especially since systematic deviations detected in the manufacturing process can be prospectively taken into account when creating/altering the CAD/CAM data 34 for the relevant 3D structure 12 and/or the manufacturing process.

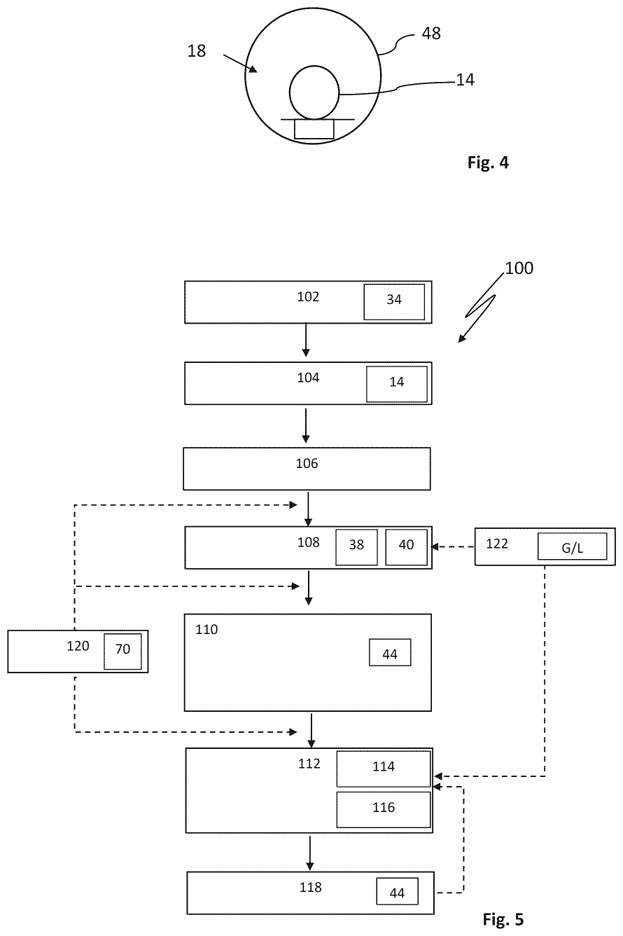

According to FIG. 4, the working zone 18 of the apparatus can be delimited by means of a, preferably gas-tight, housing 48. The housing 48 can be made, for example, of plastic or glass or another material which is non-shielding against RF fields or magnetic fields. The housing 48 can be formed, for example, by a plastic film in which the starting material 14 is arranged.

A pump 50 (FIG. 1) can be assigned to the working zone of the apparatus 12, by means of which the atmosphere within the housing 48 can be evacuated or substantially evacuated and/or by means of which the working zone 18 within the housing 48 can be filled with a fluid specified for the manufacturing process, in particular a defined working atmosphere. In this way, for example, undesirable oxidative processes of the starting material 14 by oxygen can be counteracted, or a so-called superficial vapor smoothing of the 3D structure can be achieved.

The system 10 is universally suitable for the production of any, in particular smaller 3D structures 12, especially with complex geometry, and can be used, for example, to manufacture machine elements, articles of daily use and medical implants.

Below, the method 100 for generating the 3D structure 12 is explained in more detail with additional reference to the block diagram shown in FIG. 5.

The method 100 for producing the 3D structure 12 (FIG. 1) necessarily presupposes the use of the system 10 described above in the context of FIGS. 1 to 4 with the apparatus 12 and with the starting material to be processed.

The procedure comprises the following steps: a) defining 102 CAD/CAM data 34 for the 3D structure 12 to be produced; b) providing 104 a starting material 14 to be processed, comprising a magnetocalorically excitable substance 42 distributed, preferably homogeneously, in the starting material 14; c) introducing 106 the starting material 14 into the working zone 18 of the apparatus 16; d) three-dimensional location coding 108 of a first field-free region 40 within the starting material 14 as a function of the CAD/CAM data 34 by applying at least one gradient field 38; e) magnetocalorically exciting 110 the substance 42 in the field-free region 40 by means of an alternating magnetic field 44, such that the starting material 14 is thermally induced polymerized or sintered or thermally structurally decomposed, preferably solely in the field-free region 40.

For the purpose of processing a different spatial position, i.e., a different volume of interest (VOI) 60 of the starting material 14 (cf. FIG. 2), in a further step 112 a three-dimensional location coding 112 of a further, field-free region 40 in the starting material 14 is carried out as a function of the CAD/CAM data 34 of the 3D structure 12 to be generated by means of the gradient field 38, by a relative movement 114 of the starting material 14 and the gradient field 38 relative to one another by means of the mechanical movement device 26 of the apparatus 16. Alternatively, this can be achieved by superimposing 116 the gradient field 38 with one or more further homogeneous magnetic fields B1, B2, B3 in such a way that the field-free space 40 and the further VOI 60 of the starting material 14 to be processed coincide spatially.

In step 118, the magnetocalorically excitable substance 42 in the field-free space 40 of the gradient field 38 is magnetocalorically excited so that the starting material 14 is thermally induced polymerized or sintered or thermally structurally decomposed in the field-free region 40. Steps 112 to 118 are repeated as required until the 3D structure specified by the CAD/CAM data is generated from the starting material.

The size L and/or geometry G of the respective field-free space FFR 40 can be varied as a function of the CAD/CAM data (34) by superimposing a further, preferably inhomogeneous, magnetic field G1, G2, G3 on the gradient field 38 or by means of a plurality of further, preferably inhomogeneous, magnetic fields G1, G2, G3. This is done, for example, in the optional step 122.

In the optional step 120, image data 70 can be obtained at any time for the starting material 14 and/or for the (partially) generated 3D structure 12 and the further manufacturing process of the 3D structure 12 can be continued taking into account the respective image data 70. The image data 70 can be compared with the CAD/CAM data 34 by means of the control unit and the CAD/CAM data 34 can be altered by means of the control unit if a deviation of the image data 70 from the CAD/CAM data 34 defined as maximum permissible is exceeded. In this way, a further improved dimensional accuracy of the 3D structure 12 to be produced can be achieved.

What is claimed is:

1. An apparatus for manufacturing a 3D structure from a starting material with a magnetocalorically excitable substance, on the basis of CAD/CAM data on the 3D structure, comprising:
a working zone configured for receiving the starting material to be processed;
a control unit with a memory configured for the CAD/CAM data of the 3D structure to be generated;
a gradient field generator configured for generating a gradient field by which a defined field-free space in the starting material arranged in the working zone can be spatially encoded and by which the magnetocalorically excitable substance in the starting material outside of the field-free space is positively or negatively magnetically saturated; and
an alternating field generator configured for irradiating a frequency and amplitude-modulatable alternating field into the working zone;
wherein the control unit is configured to control the alternating field generator in such a way that the magnetocalorically excitable substance of the starting material in the spatially encoded field-free space can be excited by means of the alternating field, in order to trigger:
in the case of a starting material comprising a prepolymer, thermally induced polymerization of the prepolymer to a polymer; and/or
in the case of a starting material comprising a ceramic material and/or a metallic material, sintering of the ceramic/metallic material
or a thermal structural decomposition of the starting material;
in the defined field-free space.

2. The apparatus according to claim 1, wherein the apparatus comprises a mechanical movement device configured for the spatial repositioning of the defined field-free space relative to the working zone/starting material, by means of which a mechanical relative movement of the working zone/starting material and the gradient field can be generated, and/or
in that the apparatus has one or more magnetic field generators for generating one or more homogeneous magnetic fields in the working zone, which can be superimposed on the gradient field in order to move the defined field-free space relative to the working zone/starting material.

3. The apparatus according to claim 1, wherein the apparatus has one or more magnetic field generators for generating one or more inhomogeneous magnetic fields G1, G2, G3 . . . G(n) in the working zone, which can be superimposed on the gradient field in order to change the geometry and/or size of the defined field-free space, on the basis of the CAD/CAM data.

4. The apparatus according to claim 1, wherein the apparatus has an imaging unit for obtaining image data from the working zone, wherein the control unit is configured to compare the image data with the CAD/CAM data of the 3D structure and, if deviations, being geometric deviations, between image data and CAD/CAM data are detected, to take the image data or the deviations into account for the further manufacturing process of the 3D structure and/or in that the control unit is configured to alter the CAD/CAM data on the basis of the image data.

5. The apparatus according to claim 1, wherein the field frequency of the alternating field is between 1 KHz and 1 GHz.

6. The apparatus according to claim 1, wherein the field frequency of the alternating field is between 10 KHz and 1 MHz.

7. The apparatus according to claim 1, wherein the field frequency of the alternating field is between 100 KHz and 500 KHz.

8. A system for manufacturing a 3D structure from a starting material with a magnetocalorically excitable substance on the basis of CAD/CAM data of the 3D structure, comprising the apparatus according to claim 1 and the starting material with the magnetocalorically excitable substance.

9. A method for manufacturing a 3D structure by means of the system according to claim 8, comprising the following steps:
defining CAD/CAM data for the 3D structure to be produced;
providing a starting material to be processed, comprising a magnetocalorically excitable substance distributed, preferably homogeneously, in the starting material;
introducing the starting material into the working zone of the apparatus;
spatially encoding a first field-free space within the starting material by applying at least one gradient field, wherein the magnetocalorically excitable substance in the starting material outside the field-free space (40) is positively or negatively magnetically saturated;
magnetocalorically exciting the substance in the field-free space by irradiation of an alternating magnetic field, such that the starting material, preferably solely in the field-free space, is thermally induced polymerized or sintered or is thermally structurally decomposed.

10. The method according to claim 9, including the steps of:
spatially encoding a further field-free space in the starting material by means of the gradient field as a function of the CAD/CAM data of the 3D structure to be generated; and
magnetocalorically exciting the magnetocalorically excitable substance in the further field-free space by the alternating field, such that the starting material in the field-free space is thermally induced polymerized or sintered or is thermally structurally decomposed.

11. The method according to claim 10, wherein for spatial encoding of the further field-free space:
the starting material and the gradient field are moved relative to each other by means of a mechanical movement device of the apparatus; or
the gradient field is superimposed with one or with several further, being homogeneous, magnetic fields B1, B2, B3.

12. The method according to claim 9, including defining the size and/or geometry of the respective field-free space as a function of the CAD/CAM data by superimposing the gradient field with a further, inhomogeneous, magnetic field G1, G2, G3 or with several further, inhomogeneous, magnetic fields G1, G2, G3.

13. The method according to claim 9, including obtaining image data from the starting material and/or the partially generated 3D structure, and further manufacturing of the 3D structure taking into account the image data.
